(19) United States
(12) Patent Application Publication
(10) Pub. No.: US 2014/0201678 A1
(43) Pub. Date: Jul. 17, 2014

(54) IDENTIFYING AND HIGHLIGHTING CRITICAL POPUPS IN A MULTI-WINDOW ENVIRONMENT

(71) Applicant: INTERNATIONAL BUSINESS MACHINES CORPORATION, Armonk, NY (US)

(72) Inventor: Jing Xue Shen, Singapore (SG)

(73) Assignee: INTERNATIONAL BUSINESS MACHINES CORPORATION, Armonk, NY (US)

(21) Appl. No.: 13/742,406

(22) Filed: Jan. 16, 2013

(51) Int. Cl. G06F 3/0484

(52) U.S. Cl. CPC G06F 3/0484
USPC 715/788

(57) ABSTRACT

Provided are techniques for the identification and display of critical messages including displaying a default desktop on a computing system; detecting a first popup message; making a first determination that the first popup message conforms with user specified criteria; and in response to the first determination generating a first emergency desktop; populating the first emergency desktop with the first popup message; and displaying the first emergency desktop in place of the default desktop on the computing system.

### FIELD OF DISCLOSURE

The claimed subject matter relates generally to graphical based computer systems and, more specifically, to techniques for bringing attention to critical popup messages in a multi-window environment.

### BACKGROUND OF THE INVENTION

Most modern graphical user interface (GUI) based computing systems support multi-tasking, or the ability to run multiple applications concurrently. In a multi-window environment, different applications are typically displayed in different display areas, or windows, which typically are rendered on a user's display, or “desktop.” In addition, any particular application may have one or more corresponding windows. Windows are typically displayed with equal priority and urgency. If the importance of any particular window is not taken into consideration, a critical window may be obscured, or hidden, by one or more other windows.

A few examples of windows that may be more critical or urgent than others are those relating to machine reboot notification, urgent patch installation notification, a warning of detected virus or malware, a warning of a system resource shortage and a notification of a dropped network connection. In addition, different warnings and messages may have corresponding levels of urgency.

### SUMMARY OF THE INVENTION

Provided are techniques for bringing attention to critical popup messages in a multi-window environment. Techniques for the identification and display of critical messages include displaying a default desktop on a computing system; detecting a first popup message; making a first determination that the first popup message conforms with user specified criteria; and in response to the first determination generating a first emergency desktop; populating the first emergency desktop with the first popup message; and displaying the first emergency desktop in place of the delimit desktop on the computing system.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following, detailed description of the disclosed embodiments is considered in conjunction with the following figures.

FIG. 1 is a block diagram of a computing system architecture on which the claimed subject matter may be deployed.

FIG. 2 is a block diagram of a Critical Message Priority Alert System (CMPAS) that may implement the claimed subject matter.

FIG. 3 is a flowchart of one example of a Setup CMPAS process that may implement aspects of the claimed subject matter.

FIG. 4 is a flowchart of one example of an Operate CMPAS process that may implement aspects of the claimed subject matter.

FIG. 5 is a flowchart of one example of a Manage Desktops process that may implement aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may he utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As the Inventors herein have realized, it would be advantageous in a GUI based computing system to automatically detect that a particular window corresponds to a critical or urgent message. As explained above, examples of such messages may include, but are not limited to messages concerning machine reboot, urgent patch installation, a detected virus or malware, system resource shortage and a dropped network connection. Provided is a “highlighting” display area, or desktop, that is displayed only in conjunction with urgent messages. The highlighting desktop may be closed and the computing device switched to a normal desktop once a user has responded to the urgent message.

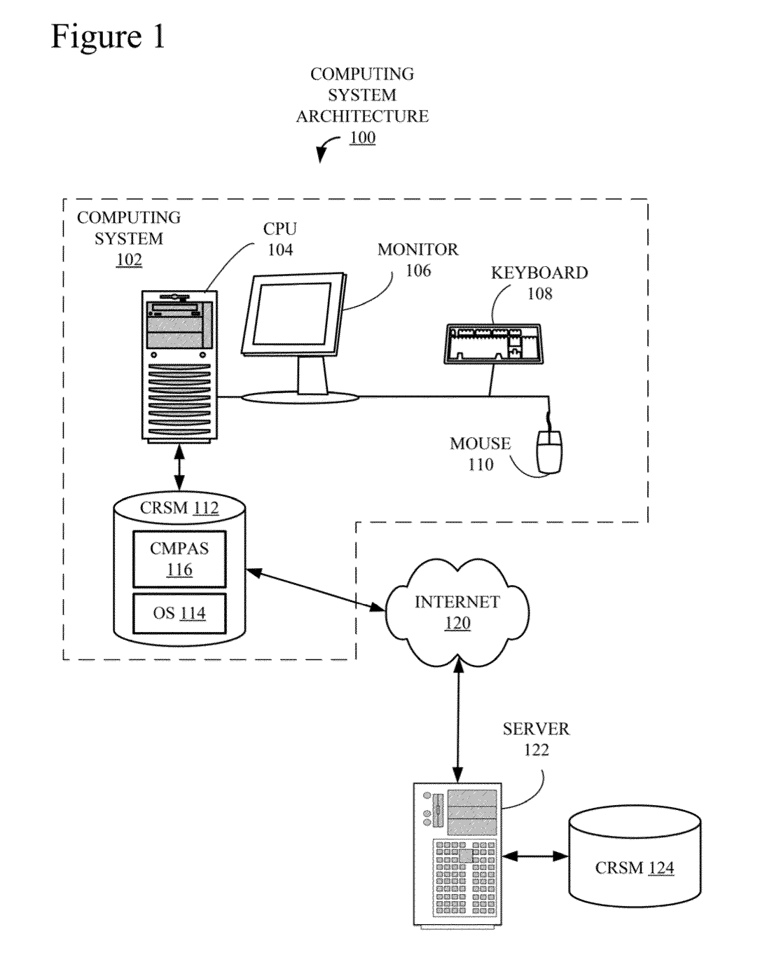

Turning now to the figures. FIG. 1 is a block diagram of an exemplary computing system architecture 100 that incorporates the claimed subject matter. A computing system 102 includes a central processing unit (CPU) 104, coupled to a monitor 106, a keyboard 108 and a pointing device, or “mouse,” 110, which together facilitate human interaction with computing system 100 and computing system 102. Also included in computing system 102 and attached to CPU 104 is a computer-readable storage medium (CRSM) component 112, which may either be incorporated into computing system 102 i.e. an internal device, or attached externally to CPU 104 by means of various, commonly available connection devices such as but not limited to, a universal serial bus (USB) port (not shown).

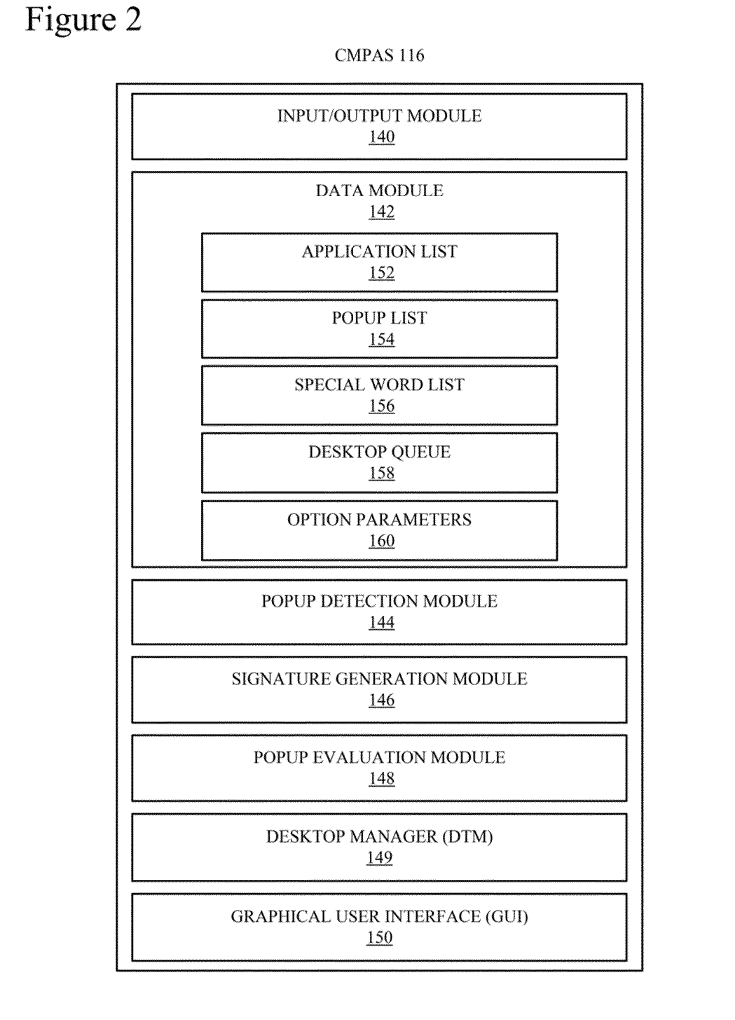

CRSM 112 is illustrated storing an operating system (OS) 114 and a Critical Message Priority Alert System (CMPAS) 116, which may implement the claimed, subject matter. Although illustrated as a stand-alone application within computing system 102, CMPAS 116 may also be implemented as plugin module in conjunction with OS 114 and as an application programming interface (API) library to provide application development integration, thus offering the capability of displaying critical popup windows on an displaying application by application basis. CMPAS 116 is described in more detail below in conjunction with FIGS. 2-5.

Computing system 102 and CPU 104 are connected to the Internet 120, which is also connected to a server computer 122. Although in this example, computing system 102 and server 122 are communicatively coupled via the Internet 129, they could also be coupled through any number of communication mediums such as, but not limited to, a local area network (LAN) (not shown). Like computing system 102, server 122 includes a CRSM 124 and would typically include a CPU, a monitor, keyboard and mouse, which for the sake of simplicity are not shown.

In this example CMPAS 116 is implemented on computing system 102; it could also be implemented as a service for a computing device such as computing system 102 and originating from another device such as server 122. Server 122 and Internet 120 are also provided as examples of sources from which critical messages may originate. Further, it should be noted there are many possible computing system configurations, of which computing system 100 and computing system 102 are only one simple example.

FIG. 2 is a block diagram of CMPAS 116, introduced above in FIG. 1, in greater detail. CMPAS 116 includes an input/output (I/O) module 140, is data module component 142, a popup detection module 144, a signature generation module 146, a popup evaluation module 148, a desktop manager (DTM) 149 and a graphical user interface (GUI) 150. For the sake of the following examples, CMPAS 116 is assumed to execute on computing system 102 (FIG. 1) and stored in CRSM 112 (FIG. 1). It should be understood that the claimed subject matter can be implemented in many types of computing systems and data storage structures but, for the sake of simplicity, is described only in terms of computing system 102 and system architecture 100 (FIG. 1). Further, the representation of CMPAS 116 in FIG. 2 is a logical model. In other words, components 140, 142, 144, 146, 148, 149 and 150 may be stored in the same or separate files and loaded and/or executed within system 100 either as a single system or as separate processes interacting via any available, inter process communication (IPC) techniques.

I/O module 140 handles any communication CMPAS 116 has with other components of computing system 102. Data module 142 is a data repository for information, including operating parameters and lists, that CMPAS 116 requires during normal operation. Examples of the types of information stored in data module 142 include an application list 152, a popup list 154, a special word list 156, a desktop queue 158 and option parameters 160.

An application list 152 stores the names of processes, programs or applications that have been designated as likely sources of special, or “critical,” popups that may need to be addressed in accordance with the claimed subject matter. For example, applications such as, but not limited to, an interface with a uninterruptible power supply (UPS) (not shown), system processes, firewalls, anti-virus and anti-malware processes may be designated as likely sources of critical popups. In a similar fashion, a popup list 154 may identify specific popup screens that are known to include important messages of which a user should be made aware. Specific popup messages may be identified by stored “signatures” corresponding to known critical message popups. It should be understood that other means may be utilized to identify critical popup messages, including but not limited to, word and phrase identification and artificial intelligence techniques. In addition to designating an identified popup as critical, some popup windows may be explicitly excluded from consideration based upon entries in one or more exclusion lists (not shown) corresponding to application list 152, popup list 154 and a special word list 156.

Special words list 156 may identify specific words or phrases that would indicate a corresponding popup window should be treated as critical in accordance with the claimed subject matter. For example, the words “shutdown,” “power” and “termination” and the phrase “system must exit” may be designated as words of interest. Desktop queue 158 stores, in addition to a standard default desktop, highlighting desktops (HLDTs) employed to display critical popups. A “default” desktop is a typical desktop used to display processes, applications and non-critical popups. Option parameters 160 stores various user-set parameters that control the operation of CMPAS 116. Examples include, but are not limited to, parameters for whether or not to provide audio warnings in conjunction with critical popup warnings and modes of operation, e.g. whether popup filters are based upon applications (see 152), popups (see 154), designated words (see 156) or some combination.

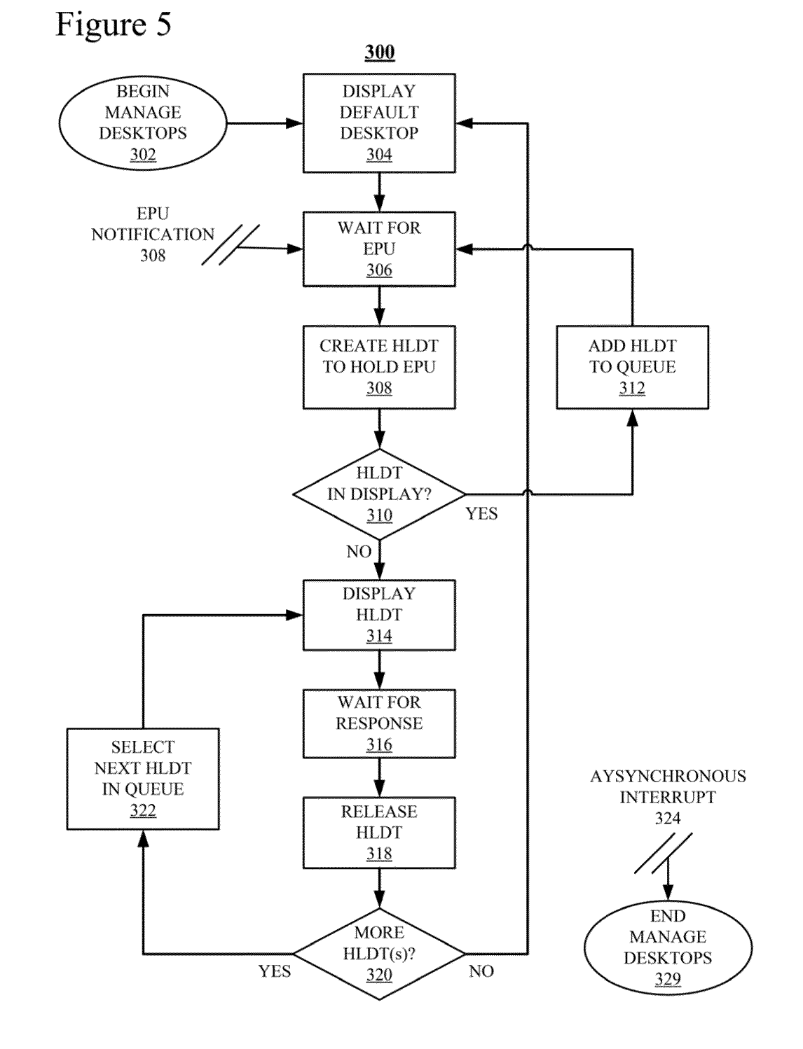

Popup detection module 144 traps, using typical GUI hooking technology, popup windows for evaluation by popup evaluation module 148. Signature generation module 146 extracts properties of a detected window, i.e., the “signature,” employed by Popup Evaluation module 148 to identify critical popups. In other words, in response to a request to render a popup window, the window is detected by popup detection module 144, a signature is generated by signature generation module 146 and evaluated by popup evaluation module 148 based upon the information stored in application list 152, popup list 154, special word list 156 and option parameters 169. If specified criteria are met, the detected popup window is designated as containing a critical message and control is passed to DTM 149 to generate an appropriate response as described below (see 300, FIG. 5).

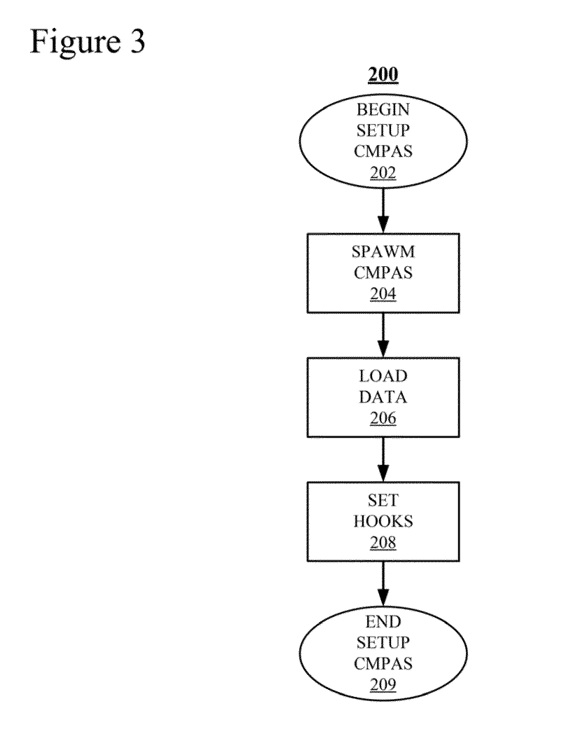

GUI 150 enables users of CMPAS 116 to interact with and to define the desired functionality of CMPAS 116 for example by setting values stored in option parameters 160. Components 140, 142, 144, 146, 148, 149, 150, 152, 154, 156, 158 and 160 are described in more detail below in conjunction with FIGS. 3-5.

FIG. 3 is a flowchart of one example of a Setup CMPAS process 200 that may implement aspects of the claimed subject matter. In this example, logic associated with process 200 is stored on CRSM 112 (FIG. 1) in conjunction with CMPAS 116 (FIGS. 1 and 2) and executed on one or more processors (not shown) of CPU 104 and computing system 102. As mentioned above logic associated with process 200 may, in the alternative, also be incorporated into OS 114 (FIG. 1) or provided as a part of an API library (not shown) and implemented on an application by application basis.

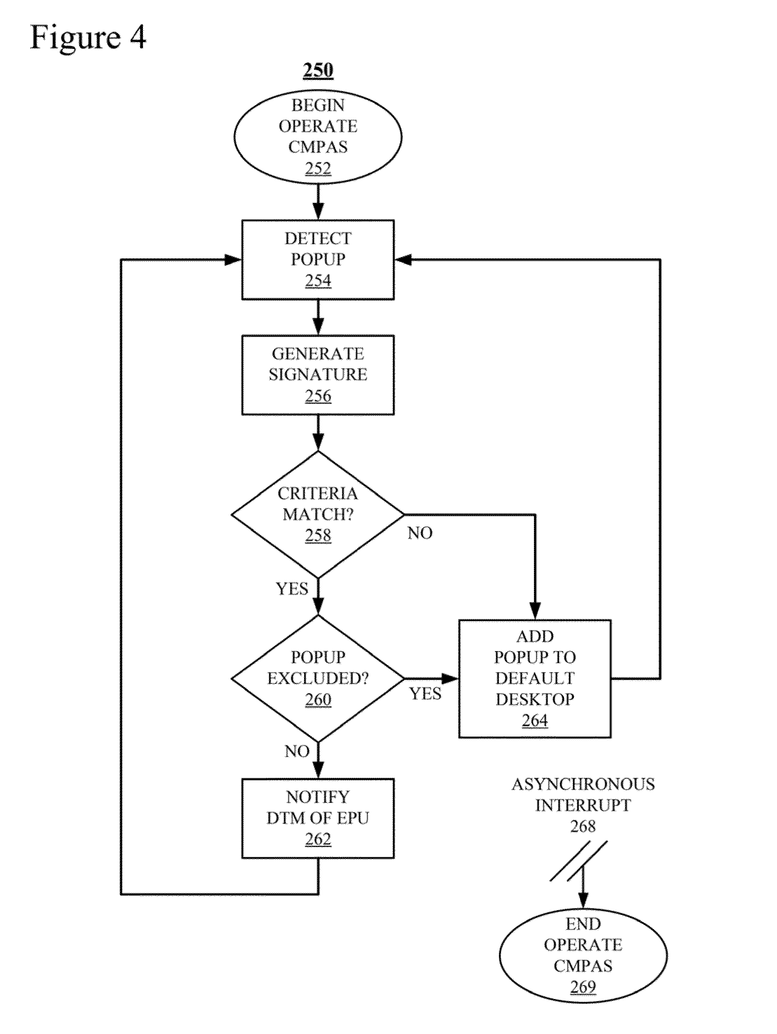

Process 200 starts in a “Begin Setup CMPAS” block 202 and proceeds immediately to a “Spawn CMPAS” block 204. During processing associated with block 204, a CMPAS process (see 250, FIG. 4) is initiated. During processing associated with a “Load Data” block 206, the process initiated during processing associated with block 204 retrieves operation and configuration data stored in CRSM 112 (see 152, 154, 156, 158 and 160. FIG. 2). Of course it should be understood that data may be retrieved from many sources other than CRSM 112 such as, but not limited to. CRSM 124 (FIG. 1) and server 122 (FIG. 1). During processing associated with a “Set Hooks” block 208, GUI hooking technology is established to detect new window popups (see 254, FIG. 4) and extract properties such as a signature (see 256, FIG. 4). Finally, during processing associated with an “End Setup CMPAS” block 209, process 200 is complete.

FIG. 4 is a flowchart of one example of an Operate CMPAS process 250 that may implement aspects of the claimed subject matter. Like process 200, in this example, logic associated with process 250 is stored on CRSM 112 (FIG. 1) in conjunction with CM PAS 116 (FIGS. 1 and 2) and executed on one or more processors (not shown) of CPU 104 and computing system 102.

Process 250 starts in a “Begin Operate CMPAS” block 252 and proceeds immediately to a “Detect Popup” block 254. During processing associated with block 254, a new popup is detected by GUI hooks set when CMPAS 116 is initiated (see 208, FIG. 3). During processing associated with a “Generate Signature” block 256. A signature corresponding to the popup detected during processing associated with block 254 is generated based upon extracted window properties or based upon an intelligent identification that singles out popups from such processes as the OS 114 (FIG. 1), a firewall and anti-virus or malware detection (not shown).

During processing associated with a “Criteria Match?” block 258, a determination is made as to whether or not the signature generated during processing associated with block 256 corresponds to any known signature (see 154, FIG. 2) of a critical popup identified as one which should be handled in accordance with the disclosed technology. It should be noted that in addition to a signature match, there are also other means to identify a critical popup including, but not limited to, the presence of particular words (see 156, FIG. 2), a correspondence to a particular application or process (see 152, FIG. 2) or any current or yet to be developed means that employ techniques such as, but not limited to, artificial intelligence.

If, during processing associated with block 258, a determination is made that the popup detected during processing associated with block 254 is a critical popup, control proceeds to a “Popup Excluded?” block 269. During processing associated with block 269, a determination is made as to whether or not the popup identified as critical during processing associated with block 258 has been excluded as a popup (see 152, 154, and 156, FIG. 2) designated for treatment in accordance with the disclosed technology. If not, control proceeds to a “Notify Desktop Manager (DTM) of Emergency Popup (EPU)” block 262 (see 308, FIG. 5). It should be noted that an “EPU,” which stands for emergency popup, has previously been referred to as a “critical popup.” The acronym EPU is being employed rather than an acronym for critical popup, “CPU,” to prevent confusion with respect to CPU 104 (FIG. 1). During processing associated with block 262, an interrupt is transmitted to DIM 149 (FIG. 2) to notify a Manage Desktop process 300 sec FIG. 5) that a EPU is to be processed.

If, during processing associated with block 258, a determination is made that the popup detected during, processing associated with block 254 is not a critical popup or, if during processing associated with block 260, a determination is made that the detected popup is explicitly excluded, control proceeds to an Add Popup to Default Desktop” block 264. During processing associated with block 264, the detected popup is simply introduced into the default desktop. One the popup has been added to the default popup during processing associated with block 264 or DTM 149 has been notified during processing associated with block 262, control returns to Detect Popup block 254 during which process 250 awaits detection on another popup and processing continues as describe above.

Finally, process 250 is halted by means of an asynchronous interrupt 268, which passes control to an “End Operate CMPAS” block 269 in which process 250 is complete. Interrupt 268 is typically generated when the OS, computing system, application, etc. of which process 250 is a part is itself halted. During normal operation, process 250 continuously loops through the blocks 254, 256, 258, 260, 262 and 264, processing new popup windows as received.

FIG. 5 is a flowchart of one example of a Manage Desktops process 300 that may implement aspects of the claimed subject matter. In this example, logic associated with process 300 is stored on CRSM 112 (FIG. 1) in conjunction with DTM 149 (FIG. 2) of CMPAS 116 (FIGS. 1 and 2) and executed on one or more processors (not shown) of CPU 104 and computing system 102.

Process 300 starts in “Begin Manage Desktops” block 302 and proceeds immediately to a “Display Default Desktop” block 304. During processing associated with block 304, a default desktop is display, in this example on monitor 106 (FIG. 1) of computing system 102. As explained above a default desktop is a desktop that is typically displayed in conjunction with OS 114 (FIG. 1). Typically, when process 300 is first initiated, one or more default desktops are the only desktops identified in desktop queue 158 (FIG. 2). During processing associated with a “Wait for Emergency Popup (EPU)” block 306, process 300 is suspended while waiting for an EPU Notification 308, which is an interrupt transmitted by process 250 (see 262, FIG. 4). Once interrupt 308 has been received control proceeds to a “Create HLDT to Hold EPU” block 308. During processing associated with block 308, a new highlighted desktop (HLDT) is created and the detected popup (see 254, FIG. 4) that is determined to be critical (see 258, FIG. 4) and not excluded (see 260, FIG. 4) is added to the newly created desktop.

During processing associated with a “HLDT in Display?” block 310, a determination is made as to whether or not monitor 106 is already displaying a HLDT corresponding to a previously detected EPU. If so, control proceeds to an “Add HLDT to Queue” block 312. During processing associated with block 312, information identifying the HLDT generated during processing associated with block 308 is added to desktop queue 158. It should be understood that although in the example desktop queue 158 is basically a last-in first-out (LIFO) queue, i.e. a stack, other schemes are equally applicable. For example, a priority scheme may be implemented that assigns a priority to HLDTs based upon their perceived importance as specified by user-defined parameters.

If, during processing associated with block 310, a determination is made that a HLDT is not already being displayed, i.e. the default desktop is displayed, control proceeds to a “Display HLDT” block 314 during which the generated is displayed in monitor 106 in conjunction with the detected popup. During processing associated with a “Wait for Response” block 316, process 300 pauses to wait for some indication that the a user of computing system 102 has seen and taken an appropriate action with respect to the displayed popup. Once that response is received, control proceeds to a “Release HLDT” block 318. During processing associated with block 318, the HLDT that was displayed during processing, associated with block 314 is released, i.e. resources of computing system 102 that have been allocated are released and entries corresponding to the particular HLDT in desktop queue 158 are removed.

During processing associated with a “More HLDT(s)” block 320, a determination is made as to whether or not there are addition HLDTs in desktop queue 158. It should be noted that during processing associated with blocks 314, 316, 318, 320 and 322 another request for a HLDT may be received in conjunction with interrupt 308. Therefore, there may be multiple HLDTs in desktop queue 158, added in conjunction with block 312. If there are more HLDTs in desktop queue 158 control proceeds to a “Select Next HLDT in Queue” block 322. During processing associated with block 322, the next HLDT in desktop queue to display is selected. As explained above, there may be multiple schemes for selecting the next HLDT such as a LIFO, a first-in, first-out (FIFO) and a scheme that assigns different priorities to different HLDTs. The particular scheme may he specified by a value stored in option parameters 160 (FIG. 2). Once the next HLDT has been selected, control returns to block 314 and the selected HLDT is displayed in monitor 106. If, during processing associated with block 320, a determination is made that there are no HLDTs in desktop queue 158, control returns to block 304, the default desktop is displayed and processing continues as described above.

Finally, process 300 is halted by means of an asynchronous interrupt 324, which passes control to an “End Manage Desktops” block 329 in which process 300 is complete. Interrupt 324 is typically generated when the OS, computing system, application, etc. of which process 250 is a part is itself halted. During normal operation, process 300 continuously loops through the blocks 304, 306, 308, 310, 312, 314, 316, 318, 320 and 322, processing EPU notifications 308 and user responses 316 as received.

The terminology used herein is for the purpose of describing particular embodiments only and is not intended to be limiting of the invention. As used herein, the singular forms “a”, “an” and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended, to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, he executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising:
detecting a first popup message associated with a default desktop displayed on a computing system;
making a first determination that the first popup message conforms with user specified criteria;
and in response to the first determination:
generating a first emergency desktop;
populating the first emergency desktop with the first popup message; and
enabling a display of the first emergency desktop on the computing system in place of the default desktop.

2. The method of claim 1, wherein the first popup message is evaluated for conformity with the first user specified criteria by one or more procedures, the procedures comprising:
a first procedure comprising:
generating a first signature corresponding to the first popup message; and
matching the first signature to a second signature stored on a computer readable storage medium;
a second procedure comprising correlating the first popup message with a specified process;
a third procedure comprising detecting a plurality of keywords in the first popup message; and
a fourth procedure comprising correlating the first popup message with one or more GUI control properties, the one or more GUI control properties comprising:
window title;
window dialog ID;
window class ID;
parent/owning window; and
owning application/process.

3. The method of claim 1, further comprising:
making a second determination that a response has been received with respect to the emergency popup message; and, in response to the second determination; and
enabling the display of the default desktop on the computing system rather than the first emergency desktop.

4. The method of claim 1, the detecting comprising:
setting an operating system hook to monitor popup windows; and
extracting properties, for the generating; of the first signature, from a detected popup.

5. The method of claim 1, further comprising:
detecting a second popup message;
making a second determination that the second popup message confirms with the user specified criteria;
making a third determination that the first emergency desktop is displayed on the computing system; and, in response to the second and third determination:
generating a second emergency desktop;
populating the second emergency desktop with the second popup message; and
storing the second emergency desktop in a desktop queue.

6. The method of claim 5, further comprising making a forth determination that a response has been received with respect to the first popup message; and, in response to the forth determination:
selecting the second emergency desktop from the desktop queue; and
enabling a display of the second emergency desktop on the computing system rather than the first emergency desktop.

7. The method of claim 6, wherein the making of the first determination depends upon a second determination that the first popup message is not an excluded popup message.

8. An apparatus, comprising:
a processor associated with a computing system;
a computer-readable storage medium coupled to the processor; and
logic, stored on the computer-readable storage medium and executed on the processor, for:
detecting a first popup message associated with a default desktop displayed on the computing system;
making a first determination that the first popup message conforms with user specified criteria;
and in response to the first determination;
generating a first emergency desktop;
populating the first emergency desktop with the first popup message; and
enabling a display of the first emergency desktop on the computing system in place of the default desktop.

9. The apparatus of claim 8, wherein the first popup message is evaluated for conformity with the first user specified criteria by one or more procedures, the procedures comprising;
a first procedure comprising:
generating a first signature corresponding to the first popup message; and
matching the first signature to a second signature stored on a computer readable storage medium;
a second procedure comprising correlating the first popup message with a specified process;
a third procedure comprising detecting a plurality of keywords in the first popup message; and
a fourth procedure comprising correlating, the first popup message with one or more GUI control properties, the one or more GUI control properties comprising:
window title;
window dialog ID;
window class ID;
parent/owning window; and
owning application/process.

10. The apparatus of claim 8, the logic further comprising logic for:
making a second determination that a response has been received with respect to the emergency popup message; and, in response to the second determination; and
enabling the display of the default desktop on the computing system rather than the first emergency desktop.

11. The apparatus of claim 8, the logic for detecting comprising logic for:
setting an operating system hook to monitor popup windows; and
extracting properties, for the generating of the first signature, from a detected popup.

12. The apparatus of claim 8, the logic further comprising logic for:
detecting a second popup message;
making a second determination that the second popup message conforms with the user specified criteria;
making a third determination that the first emergency desktop is displayed on the computing system; and, in response to the second and third determination:
generating a second emergency desktop;
populating the second emergency desktop with the second popup message; and
storing the second emergency desktop in a desktop queue.

13. The apparatus of claim 12, the logic further comprising logic for making a forth determination that a response has been received with respect to the first popup message; and, in response to the forth determination:
selecting the second emergency desktop from the desktop queue; and
enabling a display of the second emergency desktop on the computing system rather than the first emergency desktop.

14. A computer programming product, comprising;
a computer-readable storage medium; and
logic, stored on the computer-readable storage medium and executed on a processor associated with a computing system, for:
detecting a first popup message associated with a default desktop displayed on the computing system;
making a first determination that the first popup message conforms with user specified criteria;
and in response to the first determination:
generating a first emergency desktop;
populating the first emergency desktop with the first popup message; and
enabling a display of the first emergency desktop on the computing system in place of the default desktop.

15. The computer programming product of claim 14, wherein the first popup message: is evaluated for conformity with the first user specified criteria by one or more procedures, the procedures comprising:
a first procedure comprising:
generating a first signature corresponding to the first popup message; and
matching the first signature to a second signature stored on a computer readable storage medium;
a second procedure comprising correlating the first popup message with a specified process;
a third procedure comprising detecting a plurality of keywords in the first popup message; and
a fourth procedure comprising correlating, the first popup message with one or more GUI control properties, the one or more control properties comprising:
window title;
window dialog ID;
window class ID;
parent/owning window; and
owning application/process,

16. The computer programming product of claim 14, the logic further comprising logic for:
making a second determination that a response has been received with respect to the emergency popup message; and in response to the second determination; and
enabling the display of the default desktop on the computing system rather than the first emergency desktop.

17. The computer programming product of claim 14, the logic for detecting g comprising logic for:
setting an operating system hook to monitor popup windows; and
extracting properties, for the generating of the first signature, from a detected popup.

18. The computer programming product of claim 14, the logic further comprising logic for:
detecting a second popup message;
making a second determination that the second popup message conforms with the user specified criteria;
making a third determination that the first emergency desktop is displayed on the computing system; and, in response to the second and third determination:
generating a second emergency desktop;
populating the second emergency desktop with the second popup message; and
storing the second emergency desktop in a desktop queue.

19. The computer programming product of claim 18, the logic further comprising logic for making a forth determination that a response has been received with respect to the first popup message; and, in response to the forth determination:
selecting the second emergency desktop from the desktop queue; and
enabling a display of the second emergency desktop on the computing system rather than the first emergency desktop.

20. A computer display associated with a computing system, comprising:
a processor;
a computer-readable storage medium coupled to the processor; and
logic, stored on the computer-readable storage medium and executed on the processor, for:
detecting a first popup message associated with a default desktop displayed on the computer display;
making a first determination that the first popup message conforms with user specified criteria;
and in response to the first determination:
generating a first emergency desktop;
populating the first emergency desktop with the first popup message; and
enabling a display of the first emergency desktop on the computer display in place of the default desktop.

21. The computer display of claim 20, wherein the first popup message is evaluated for conformity with the first user specified criteria by one or more procedures, the procedures comprising:
a first procedure comprising:
generating a first signature corresponding to the first popup message; and
matching the first signature to a second signature stored on a computer readable storage medium;
a second procedure comprising correlating the first popup message with a specified process;
a third procedure comprising detecting a plurality of keywords in the first popup message; and
fourth procedure comprising correlating, the first popup message with one or more GUI control properties, the one or more GUI control properties comprising:
window title;
window dialog ID;
window class ID;
parent/owning window; and
owning application/process.

22. The computer display of claim 20, the logic further comprising logic for:
making a second determination that a response has been received with respect to the emergency popup message; and, in response to the second determination; and
enabling the display of the default desktop on the computing system rather than the first emergency desktop.

23. The computer display of claim 20, the logic for detecting comprising logic for:
setting an operating system hook to monitor popup windows; and
extracting properties, for the generating of the first signature, from a detected popup.

24. The computer display of claim 20, the logic further comprising logic for:
detecting, a second popup message:
making a second determination that the second popup message conforms with the user specified criteria;
making a third determination that the first emergency desktop is displayed on the computer display; and, in response to the second and third determination:
generating a second emergency desktop;
populating the second emergency desktop with the second popup message; and
storing the second emergency desktop in a desktop queue.

25. The computer display of claim 24, the logic further comprising logic for making a forth determination that a response has been received with respect to the first popup message; and, in response to the forth determination:
selecting the second emergency desktop from the desktop queue; and
enabling a display of the second emergency desktop on the computer display rather than the first emergency desktop.
